(19) United States
(12) Patent Application Publication
(10) Pub. No.: US 2009/0224892 A1
(43) Pub. Date: Sep. 10, 2009

(54) MOBILE RFID TAG TRACKING SYSTEM USING CELLULAR SYSTEMS

(75) Inventor: Charles W. T. Nicholls, Nepean (CA)

Correspondence Address: WITHROW & TERRANOVA, P.L.L.C., 100 REGENCY FOREST DRIVE, SUITE 160, CARY, NC, 27518, US

(73) Assignee: NORTEL NETWORKS LIMITED, St. Laurent, PQ (CA)

(21) Appl. No.: 11/573,469

(22) PCT Filed: Aug. 25, 2005
(86) PCT No.: PCT/IB05/02539

§ 371 Date: Feb. 9, 2007

(51) Int. Cl. G06K 7/00

(52) U.S. Cl. 340/10.42

(57) ABSTRACT

A system is provided for tracking a RFID tag within or outside of a cellular network. Upon receiving a request to track the RFID tag, the cellular network instructs each mobile host within the cellular network to track the RFID tag. When the RFID tag enters a coverage area of one of the mobile hosts, the ID of the RFID tag is communicated to the mobile host. Then, the mobile host obtains its location. At this point, if the mobile host is outside of the cellular network, the mobile host communicates with other mobile hosts within its coverage area such that all of the mobile hosts within its coverage area have the location and time stamp for the RFID tag. When one of these mobile hosts enters the cellular network, the mobile host communicates the location and time stamp for the RFID tag to the cellular network.

This application claims the benefit of U.S. provisional patent application Ser. No. 60/606,051, filed Aug. 31, 2004, the disclosure of which is hereby incorporated by reference in its entirety.

### FIELD OF THE INVENTION

The present invention relates to tracking the location of a Radio Frequency Identification (RFID) tag attached to an object using a cellular network and more particularly relates to tracking the RFID while within and outside of the cellular network.

### BACKGROUND OF THE INVENTION

In today's society, there is an ever increasing number of kidnappings and burglaries, and the focus on Homeland Security has become of utmost importance. Accordingly, it is desirable to monitor the movement of entities such as children, automobiles, weapons, and the like. However, to date, no system exists for tracking the movement of entities across a large geographic area such as a city, state, or country. Thus, there is a need for a system for tracking the movement of valuable entities over a large geographic area.

### SUMMARY OF THE INVENTION

The present invention provides a system for tracking a Radio Frequency Identification (RFID) tag within or outside of a cellular network using mobile hosts associated with the cellular network. In general, a person or entity sends a request for the location of the RFID tag to a processing node of the cellular network. The processing node of the cellular network then instructs each mobile host within the cellular network to track the RFID tag. When any RFID tag enters a coverage area of one of the mobile hosts, the identification indicia (ID) of the RFID tag is communicated to the mobile host. The mobile host determines if the RFID tag is the one to be tracked. If so, the mobile host obtains its location and stores the location and a time stamp for the RFID tag. The mobile host provides the location and time stamp of the RFID tag to other mobile hosts using a broadcast transceiver or other wireless communication device directly without using the cellular network. More specifically, when other mobile hosts enter a coverage area of the mobile host, the location and time stamp for the RFID tag are provided to the other mobile hosts. Thereafter, each of the mobile hosts having the location and time stamp for the RFID tag continues to communicate the location and time stamp to other mobile hosts. In the event that two mobile hosts communicate location information to each other regarding the same RFID tag, then the location associated with the most recent time stamp takes precedence. Consequently, if the mobile host receiving the broadcast transmission from another mobile host has location information that has a more recent time stamp than the location information being broadcast, the location information of the receiving mobile host will not change. Conversely, if the receiving mobile host location information is less recent than the location information being broadcast, then the location information at the receiving mobile host will be updated. In this manner, each of the mobile hosts obtains the most recent location information for the RFID tag. When one of the mobile hosts having the location and time stamp for the RFID tag enters the cellular network, the mobile host provides the location and time stamp of the RFID tag to the processing node via the cellular network. The processing node stores the location and time stamp of the RFID tag and communicates the location, and optionally the time stamp, to the requesting person or entity.

Those skilled in the art will appreciate the scope of the present invention and realize additional aspects thereof after reading the following detailed description of the preferred embodiments in association with the accompanying drawing figures.

### BRIEF DESCRIPTION OF THE DRAWING FIGURES

The accompanying drawing figures incorporated in and forming a part of this specification illustrate several aspects of the invention, and together with the description serve to explain the principles of the invention.

FIG. 1 illustrates an exemplary system for tracking a Radio Frequency Identification (RFID) within and external to a cellular network according to one embodiment of the present invention;

FIG. 2 is a data management diagram of the system of FIG. 1;

FIG. 3A illustrates an exemplary active RFID according to one embodiment of the present invention;

FIG. 3B illustrates an exemplary passive RFID according to one embodiment of the present invention;

FIG. 4 is an exemplary embodiment of a mobile host including a transceiver enabling communication with the cellular network, a broadcast transceiver enabling communication with an RFID and other mobile hosts, and a Global Positioning System (GPS) receiver;

FIG. 5 is a second exemplary embodiment of a mobile host including a transceiver enabling communication with the cellular network, a broadcast transceiver enabling communication with an RFID and other mobile hosts, and a Global Positioning System (GPS) receiver; and

FIG. 6 is a more detailed block diagram illustrating the processing node of the cellular network illustrated in FIG. 2.

### DETAILED DESCRIPTION OF THE PREFERRED EMBODIMENTS

The embodiments set forth below represent the necessary information to enable those skilled in the art to practice the invention and illustrate the best mode of practicing the invention. Upon reading the following description in light of the accompanying drawing figures, those skilled in the art will understand the concepts of the invention and will recognize applications of these concepts not particularly addressed herein. It should be understood that these concepts and applications fall within the scope of the disclosure and the accompanying claims.

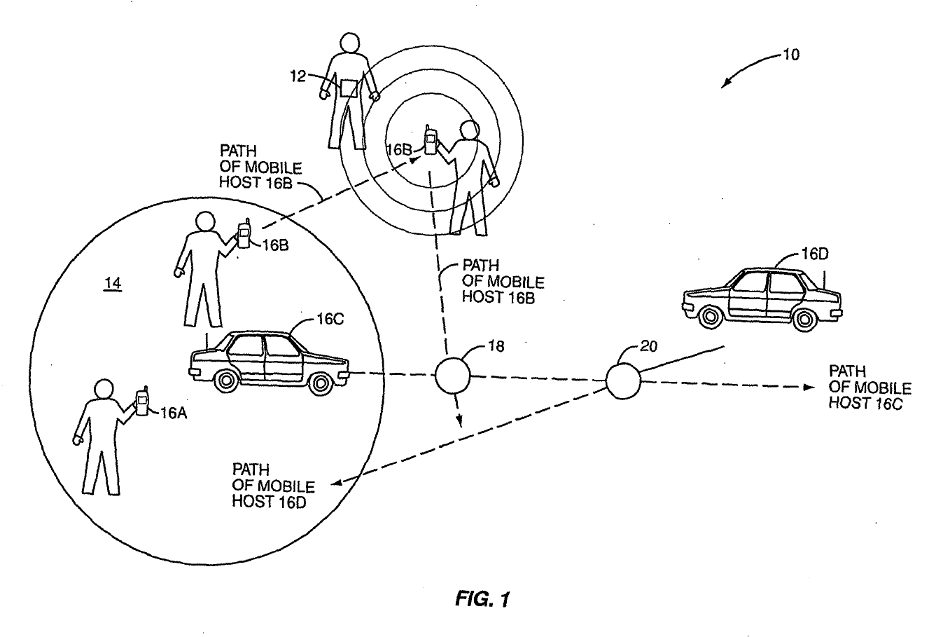

As illustrated in FIG. 1, the present invention provides a system 10 for tracking an Radio Frequency Identification (RFID) tag 12 or similar device within or external to a cellular network 14 using mobile hosts 16 (16A-16D) associated with the cellular network 14. There may be any number of RFID tags 12 in the system 10. However, for clarity, only one RFID tag 12 is illustrated. In one embodiment, RFID tag 12 operates in one of the Industrial, Scientific, or Medical (ISM) bands, which are 900 MHz, 2.4 GHz, and 5.8 GHz. Further, exemplary embodiments of the RFID tag 12 may have a transmission range in the range of and including 1 m to 100 m. Longer or shorter transmission ranges may be used as needed or desired. The RFID tag 12 may be attached to various types of objects, persons, or animals that are desired to be tracked, which are generally referred to herein as tagged objects. For example, the RFID tag 12 may be attached to a passport, inventory, children, prisoners, automobiles, and the like. In one embodiment, when it is desirable to track a person or animal, the RFID tag 12 may be implanted into the person or animal. Also, the any of the mobile hosts 16 may operate as an RFID tag through the association of a unique identification code that the mobile host 16 broadcasts in an identical fashion to an active RFID tag.

In its simplest form, the RFID tag 12 stores and communicates an identification indicia (ID) associated with the person, animal, or object to be tracked. The RFID tag 12 may also obtain dynamic information relating to the tagged object such as health status of a person or animal in terms of heart rate, temperature, or blood pressure. Other types of dynamic information may include information indicating whether the RFID tag 12 has been removed from the tagged object and information indicating whether the tagged object, such as a child, has actively placed the RFID tag 12 into a panic state by, for example, pressing a panic button.

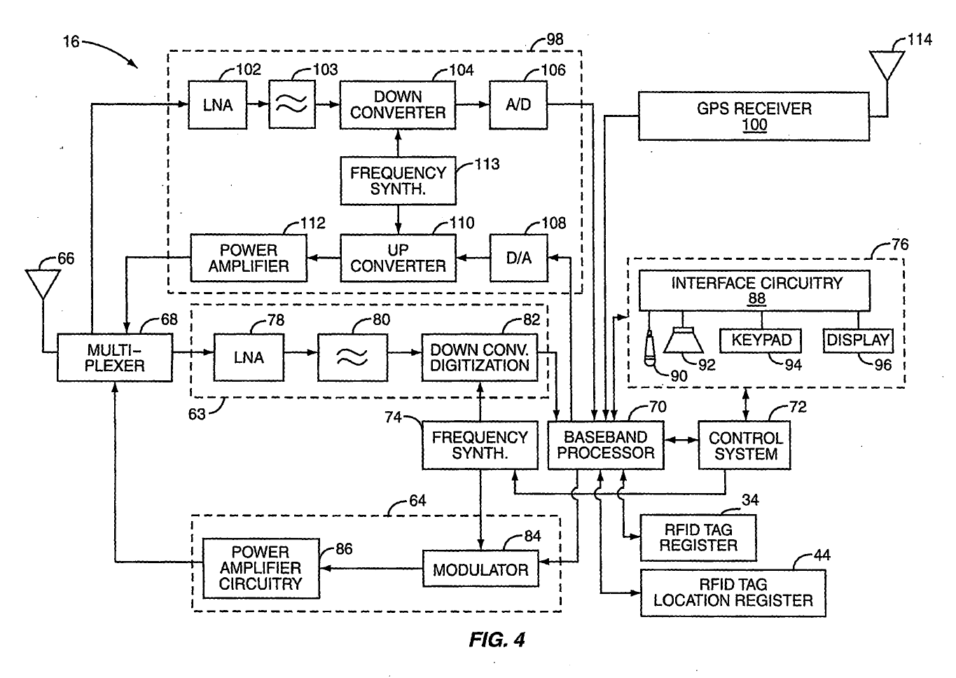

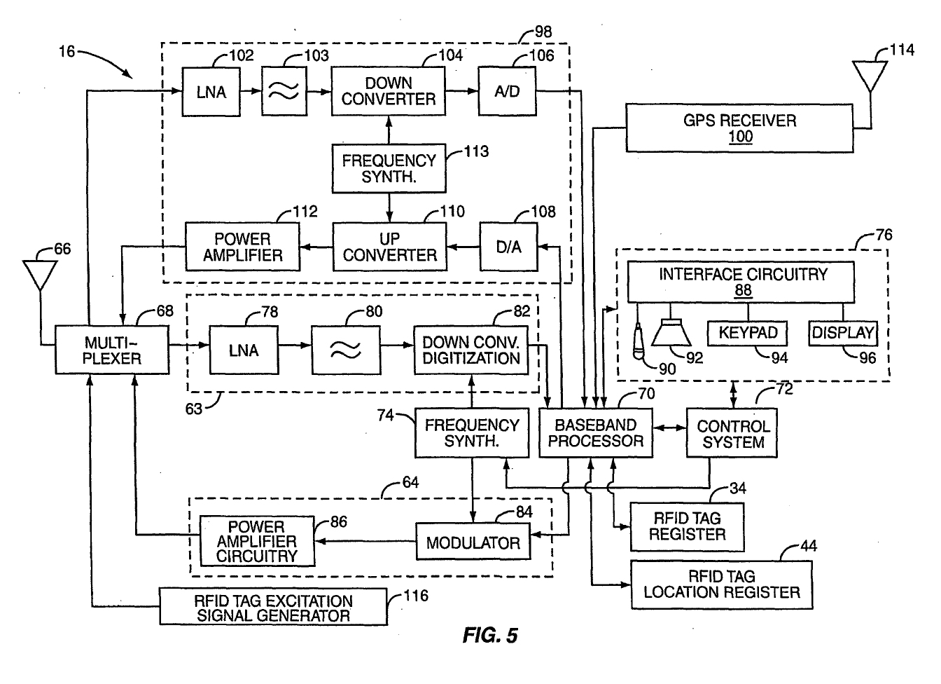

The mobile hosts 16 are mobile devices having transceivers for communicating with the cellular network 14. For example, the mobile hosts 16 may be mobile telephones 16A, 16B or a device 16C, 16D installed in a mobile vehicle such as an automobile. In addition, each of the mobile hosts 16 includes a broadcast transceiver, or other wireless communication circuitry, and location system such as a Global Positioning System (GPS) receiver (see FIGS. 4 and 5). The broadcast transceiver enables direct communication with the RFID tag 12 and other mobile hosts 16, and the location system provides the location of the mobile host 16 when desired. Like the RFID tag 12, in one embodiment, the broadcast transceiver operates in one of the Industrial, Scientific, or Medical (ISM) bands, which are 900 MHz, 2.4 GHz, and 5.8 GHz. Further, exemplary embodiments of the broadcast transceiver have a transmission range in the range of and including 1 m to 100 m. Longer or shorter transmission ranges may be used as needed or desired. Using the broadcast transceiver, the mobile host 16 may obtain the ID, and optionally additional dynamic information, from the RFID tag 12 when the RFID tag 12 is within its coverage area. In addition, the mobile host 16 may use the broadcast transceiver to communicate information indicating the IDs of the RFID tags 12 to track, the location information of the RFID tags 12 to track, and optionally dynamic information from the RFID tags 12 to track to other mobile hosts 16.

In operation, a person or entity desiring to know the location of the tagged object requests the location of the RFID tag 12 from the cellular network 14. The location of the tagged object may be requested via one of the mobile hosts 16. However, the location of the tagged object may also be requested via a land-line phone or over the internet. Many other methods of requesting the location of the tagged object will be apparent to one of ordinary skill in the art upon reading this disclosure. Various security features may be implemented to ensure that only authorized persons or entities may request the location of the RFID tag 12. For example, in one embodiment, only the parents or guardians of a child tagged with the RFID tag 12 may request the location of the RFID tag 12.

In response to receiving the request, the cellular network 14 notifies each of the mobile hosts 16 within the cellular network 14 to track the RFID tag 12. As discussed below, this may be done by updating an RFID tag register storing a list of RFID tags to track in each of the mobile hosts 16 to include the RFID tag 12. Thereafter, the mobile host 16 provides the list of RFID tags 12 to track to other mobile hosts 16 within its coverage area. In one embodiment, the mobile host 16 broadcasts the lists of RFID tags 12 to track to other mobile hosts 16 regardless of whether the mobile host 16 is within or outside of the cellular network 14. In another embodiment, the mobile host 16 broadcasts the list of RFID tags 12 to track only when outside of the cellular network 14.

When the RFID tag 12 enters the coverage area of the broadcast transceiver of one of the mobile hosts 16, the ID stored by the RFID tag 12, and optionally dynamic information, is communicated to the mobile host 16. Upon receiving the ID from the RFID tag 12, the mobile host 16 determines if the RFID tag 12 is one of the RFID tags to be tracked by comparing the ID from the RFID tag 12 to the IDs in the list of RFID tags 12 to track. If the RFID tag 12 is one of the RFID tags 12 to track, the mobile host 16 determines its location and stores the location and a time stamp for the RFID tag 12 in an RFID tag location register of the mobile host 16.

Thereafter, if the mobile host 16 is within the cellular network 14, the mobile host 16 communicates the location, time stamp, and optionally dynamic information for the RFID tag 12 to the cellular network 14. In one embodiment, the cellular network 14 periodically polls the mobile hosts 16 within the cellular network 14 for the location of the RFID tag 12, thereby initiating communication of the location, time stamp, and optionally dynamic information for the RFID tag 12 from the mobile host 16 to the cellular network 14. The cellular network 14 stores the location, time stamp, and optionally dynamic information, and communicates this information to the requesting person or entity. The location, time stamp, and optionally dynamic information for the RFID tag 12 may be cleared from the memory of the mobile host 16 after it is communicated to the cellular network 14. It should be noted that in one embodiment, the cellular network 14 may store only a predetermined number of most recent locations of the RFID tag 12. For example, the cellular network 14 may store the 100 most recent locations of the RFID tag 12 when tracking the RFID tag 12.

If the mobile host 16 is outside of the cellular network 14 when the location of the RFID tag 12 is determined, the mobile host 16 periodically transmits the IDs of the RFID tags to be tracked to other mobile hosts 16 within its coverage area using its broadcast transceiver. In addition, since the mobile host 16 has obtained the location of the RFID tag 12, the mobile host 16 periodically transmits the location, time stamp, and optionally dynamic information for the RFID tag 12 in addition to the list of RFID tags to track to other mobile hosts 16 within its coverage area using the broadcast transceiver. Thereafter, each mobile host 16 having the location, time stamp, and optionally dynamic information for the RFID tag 12 continues to broadcast this information to other mobile hosts 16. When one of the mobile hosts 16 having the location, time stamp, and optionally dynamic information for the RFID tag 12 enters the cellular network 14, that mobile host 16 communicates the location, time stamp, and optionally dynamic information for the RFID tag 12 to the cellular network 14. As discussed above, the cellular network 14 stores this information and provides the location of the RFID tag 12 to the requesting party. It should be noted that the location and time stamp of the RFID tag 12 may be communicated between any number of mobile hosts 16 outside the cellular network 14. In the event that two mobile hosts 16 transmit RFID tag location information to each other, the location with the most recent time stamp takes precedence and is used to update the location registers of the mobile hosts 16. In the event that the location and time exchange between two mobile hosts 16 with respect to the same RFID tag are identical then no update of the location registers is made.

In another embodiment, the tracking of the RFID tag 12 may be initiated by the RFID tag 12 when the RFID enters a panic state by, for example, activation of a panic button. Alternatively, the panic state may be entered automatically by the RFID tag 12 based upon dynamic information such as the blood pressure, pulse, or the like of the person to whom the RFID tag 12 is attached. If the RFID tag 12 is not already one of the RFID tags to track, the entering the panic state may add the RFID tag 12 to the list of RFID tags to track. More specifically, another mobile host 16 coming into the coverage area of the RFID tag 12 may not be tracking the RFID tag 12. However, in response to the entering the panic state, the RFID tag 12 may provide information to the mobile host 16 indicating that it is to be added to the location register as an RFID tag 12 to be tracked. The mobile host 16 may then broadcast the updated list of RFID tags 12 to track along with the location and time stamp for the RFID tag 12. Once the location and time stamp for the RFID tag 12 is communicated to the cellular network 14, the cellular network 14 may then determine that the RFID tag 12 has come online to be tracked the cellular network 14. The cellular network 14 may then alert the mobile hosts 16 within the cellular network 14 that the RFID tag 12 is to be tracked and contact emergency authorities and those paying for monitoring of the RFID tag 12. This sequence of events is different from the search being initiated by a user contacting the cellular network 14 and requesting a search in that the search is initiated by the RFID tag 12 rather than a requesting party.

Now turning to the specific example illustrated in FIG. 1, the user of the mobile host 16A requests the location of the RFID tag 12 from the cellular network 14 via the mobile host 16A. The cellular network 14 then notifies each of the mobile hosts 16A, 16B, and 16C within the cellular network 14 to track the RFID tag 12. Thereafter, the mobile host 16B moves outside of the cellular network 14, and the RFID tag 12 enters the coverage area of the broadcast transceiver of the mobile host 16B. While the RFID tag 12 is within the coverage area of the broadcast transceiver of the mobile host 16B, the ID of the RFID tag 12 and optionally dynamic information from the RFID tag 12 is communicated to the mobile host 16B. The mobile host 16B compares the ID of the RFID tag 12 to the list of RFID tags to track previously provided by the cellular network 14. Since the RFID tag 12 is to be tracked, the mobile host 16B determines its location using a GPS receiver or the like, and stores the location, a time stamp, and optionally the dynamic information for the RFID tag 12. While RFID tag 12 remains within the coverage area of the mobile host 16B, the time and location information associated with RFID tag 12 will be periodically updated. In an alternative embodiment, the RFID tag 12 may include a GPS receiver or a similar location system such that the location of the RFID tag 12 is determined by the RFID tag 12 rather than the mobile host 16B, as would be the case if a mobile host 16B were the RFID tag to be located

At some point, the mobile host 16B moves away from the RFID tag 12. Similarly, the mobile host 16C moves out of the cellular network 14. Thereafter, the mobile hosts 16B and 16C come in contact with one another at a point 18, wherein the mobile host 16C is within the coverage area of the broadcast transceiver of the mobile host 16B and vise versa. Using its broadcast transceiver, the mobile host 16B communicates the location, time stamp, and optionally dynamic information for the RFID tag 12 to the mobile host 16C. The mobile host 16C then comes into contact with the mobile host 16D at point 20, wherein the mobile host 16D is within the coverage area of the broadcast transceiver of the mobile host 16C and vise versa. Using its broadcast transceiver, the mobile host 16C communicates the IDs of the RFID tags to track, which include the ID of the RFID tag 12, to the mobile host 16D. In addition, the mobile host 16C communicates the location, time stamp, and optionally dynamic information for the RFID tag 12 to the mobile host 16D. In the event that mobile host 16D already has a time and location associated with the RFID tag 12, then the location and optionally dynamic information with the most recent time stamp takes precedence and is used to update the location register of mobile hosts 16C and 16D. Thereafter, the mobile host 16D enters the cellular network 14, and the location, time stamp and optionally dynamic information for the RFID tag 12 is communicated to the cellular network 14 from the mobile host 16D. As stated above, in one embodiment, the cellular network 14 periodically polls the mobile hosts 16 within the cellular network 14 for the location of the RFID tag 12, thereby initiating communication of the location and time stamp for the RFID tag 12 from the mobile host 16D to the cellular network 14. The cellular network 14 stores the location and time stamp for the RFID tag 12 and communicates this information to the requesting person or entity. It should be noted that in one embodiment, the cellular network 14 may store only a predetermined number of most recent locations of the RFID tag 12. For example, the cellular network 14 may store the 100 most recent locations of the RFID tag 12 when tracking the RFID tag 12.

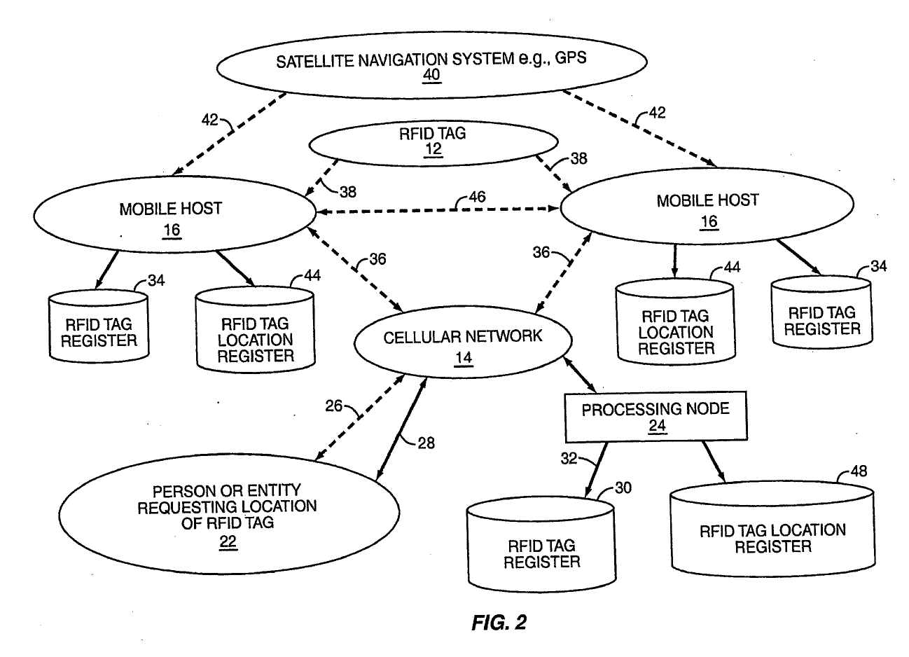

FIG. 2 is a data management diagram of the system 10 for tracking the RFID tag 12 according to one embodiment of the present invention. In general, to initiate tracking of the RFID tag 12, a person or entity 22 sends a request for the location of the RFID tag 12 to the cellular network 14. More specifically, the request is sent to a processing node 24 of the cellular network 14. In this embodiment, the processing node 24 is part of the cellular network 14. However, the processing node 24 may alternatively not be part of the cellular network 14. As used herein, dashed lines represent wireless connections and solid lines represent wired connections. Thus, as indicated by the dashed line 26, the person or entity 22 may send the request wirelessly through the cellular network 14. Alternatively, the person or entity 22 may send the request to the cellular network 14 through a wired connection (line 28). The processing node 24 of the cellular network 14 then adds the ID of the RFID tag 12 to the RFID tag register 30. In this embodiment, the connection between the processing node 24 and the RFID tag register 30 is a wired connection (line 32). The RFID tag register 30 of the cellular network 14 contains a list of every RFID tag to be tracked by the cellular network 14. The processing node 24 of the cellular network 14 then updates the RFID tag registers 34 of the mobile hosts 16 within the cellular network 14 with the ID of the RFID tag 12 to be tracked (dashed line 36).

When the RFID tag 12 enters the coverage area of the broadcast transceiver of one of the mobile hosts 16, the ID of the RFID tag 12, and optionally dynamic information, is communicated wirelessly from the RFID tag 12 to the mobile host 16, as indicated by dashed line 38. When the mobile host 16 receives the ID information from the RFID tag 12, the mobile host 16 compares the ID to the list of RFID tags to track stored in the RFID tag register 34. If the ID matches that of an RFID in the list of RFID tags to track or if the transmission from the RFID tag 12 carries a request to be tracked, such as when the panic button on the RFID tag has been pressed, the mobile host 16 then acquires the location of the mobile host 16 via a satellite navigation system 40, such as the GPS. Note if a new RFID tag 12 is added to the location register of a mobile host 16 by the RFID tag 12 being placed in panic mode, then the mobile host 16 will transfer the new ID of the new RFID tag to track to other mobile hosts 16 in its broadcast area and also to the cellular network 14. For the GPS, signals (dashed line 42) are transmitted by a constellation of satellites. Based on these signals, a GPS receiver within the mobile host 16 determines its location.

Once the mobile host 16 has determined its location, the location, time stamp, and optionally dynamic information for the RFID tag 12 are stored in a RFID tag location register 44. When the mobile hosts 16 are outside of the cellular network 14 and within the coverage area the broadcast transceiver of another mobile host 16, information indicating the RFID tags to track and the location, time stamp, and optionally dynamic information for the RFID tag 12 are exchanged (dashed line 46) such that each of the mobile hosts 16 has the most up-to-date list of RFID tags to track in their RFID tag register 32 and the location, time stamp, and optionally dynamic information for the RFID tag 12 stored in their respective RFID tag location register 44. Once either of the mobile hosts 16 re-enters the cellular network 14, the location, time stamp, and optionally dynamic information for the RFID tag 12 is communicated to the processing node 24 of the cellular network 14 (dashed line 36), and the processing node 24 stores the location, time stamp, and optionally dynamic information for the RFID tag 12 in an RFID tag location register 48. The RFID tag location register 48 stores one or more locations and corresponding time stamps for each of the RFID tags stored in the RFID tag register 30. For example, the RFID tag location register 48 may store 100 most recent locations for each RFID tag to be tracked by the cellular network 14. The processing node 24 may then communication the most recent location or all stored locations for the RFID tag 12 to the requesting person or entity 22 via wireless connection 26 or wired connection 28.

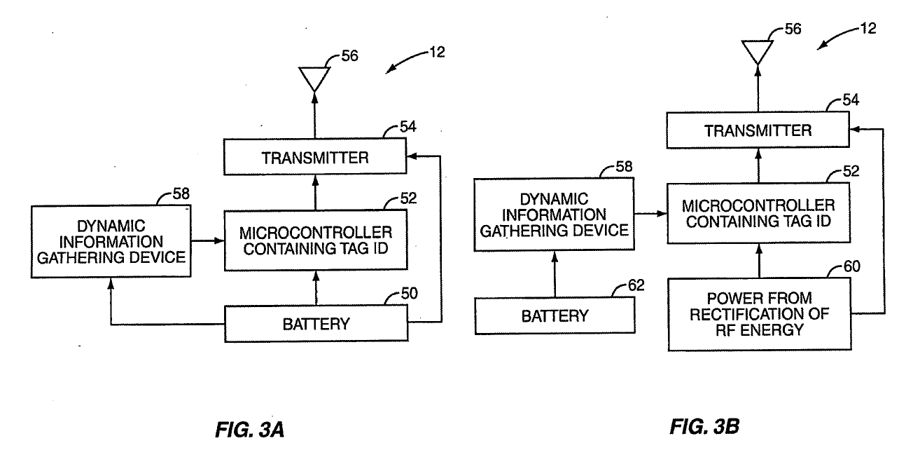

FIGS. 3A and 3B illustrate exemplary embodiments of the RFID tag 12. More specifically, FIG. 3A illustrates an exemplary embodiment of the RFID tag 12 wherein the RFID tag 12 is an active RFID tag. In this embodiment, the active RFID tag 12 includes a battery 50, a microcontroller 52, a transmitter 54, and an antenna 56. The battery 50 powers both the microcontroller 52 and the transmitter 54. The microcontroller 52 contains the ID of the RFID tag 12. In one embodiment, the microcontroller 52 periodically provides the ID of the RFID tag 12 to the transmitter 54 for transmission. In another embodiment, the transmitter 54 also includes receiver circuitry, thus making the transmitter 54 a transceiver, and the RFID tag 12 operates in a sleep mode until an interrogation signal is received from one of the mobile hosts 16. More specifically, when in the sleep mode, the RFID tag 12 does not transmit the ID of the RFID tag 12. When the RFID tag 12 receives an interrogation signal from one of the mobile hosts 16, the RFID tag 12 enters a normal mode of operation and periodically transmits the ID of the RFID tag 12, as discussed above. By operating in sleep mode until the RFID tag 12 is within the coverage area of the broadcast transceiver of one of the mobile hosts 16, the RFID tag 12 conserves the power stored by the battery 50.

The RFID tag 12 of FIG. 3A may optionally include a dynamic information gathering device 58, such as a device for monitoring the heart rate, temperature, blood pressure, or the like of a child or other person to whom the RFID tag 12 is attached. The dynamic information gathering device 58 may also obtain information indicating whether the RFID tag 12 has been removed from the tagged object or whether the tagged object such as a child has actively placed the RFID tag 12 in a panic condition. Dynamic information from the device 58 is communicated to the microcontroller 52 and transmitted to the mobile host 16 along with the ID of the RFID tag 12. If the dynamic information indicates an emergency situation, the cellular network 14 may dispatch emergency personnel upon receiving the location of the RFID tag 12 and the dynamic information. Again, it should be noted that the dynamic information gathering device 58 is optional and not necessary for the present invention.

FIG. 3B illustrates an exemplary embodiment of the RFID tag 12 wherein the RFID tag 12 is a passive RFID tag. Similarly to the active RFID tag of FIG. 3A, the passive RFID tag 12 of FIG. 3B includes the microcontroller 52, the transmitter 54, and the antenna 56. The passive RFID tag 12 also includes circuitry 60 for providing power to the microcontroller 52 and the transmitter 54 by obtaining power by rectifying received RF energy. More particularly, as known to one of ordinary skill in the art and discussed below in more detail, the mobile hosts 16 provide an RFID tag excitation signal to the RFID tag 12. The circuitry 60 receives the RFID tag excitation signal and powers the microcontroller 52 and the transmitter 54 using the power from the RFID excitation signal. When powered, the microcontroller 52 provides the ID of the RFID tag 12 to the transmitter 54 for transmission.

Similarly to the active RFID tag 12 of FIG. 3A, the passive RFID tag 12 of FIG. 3B may optionally include the dynamic information gathering device 58. In the illustrated embodiment, the device 58 is powered by a battery 62. Dynamic information from the device 58 is communicated to the microcontroller 52 and transmitted to the mobile host 16 along with the ID of the RFID tag 12. Again, it should be noted that the dynamic information gathering device 58 and the battery 62 are optional and not necessary for the present invention.

FIG. 4 is an exemplary embodiment of one of the mobile hosts 16. The mobile host 16 may be a single circuit containing the component parts illustrated in FIG. 4. The component parts of the mobile host 16 enable it to communicate via a broadcast transceiver with other mobile hosts 16, communicate with the cellular network 14 via a cellular transceiver, and receive position and time information from the GPS satellite system via a GPS receiver. Note that GPS is not the only available satellite system capable of provisioning time and location. Other positioning systems include: Glonass (Global Navigation Satellite System) and Galileio, which are a Russian version and a European version of the GPS. Hence reference to satellite navigation system is broader, with GPS being a specific embodiment.

The basic architecture of the mobile host 16 includes a receiver front end 63, a radio frequency transmitter section 64, an antenna 66, a multiplexer 68, a baseband processor 70, a control system 72, a frequency synthesizer 74, and an interface 76. The receiver front end 63 receives information bearing radio frequency signals from one or more remote transmitters provided by a base station in the cellular network 14 (FIG. 1). A low noise amplifier 78 amplifies the signal. A filter circuit 80 minimizes broadband interference in the received signal, while a downconverter 82 downconverts the filtered, received signal to an intermediate or baseband frequency signal, which is then digitized into one or more digital streams. The receiver front end 63 typically uses one or more mixing frequencies generated by the frequency synthesizer 74.

The baseband processor 70 processes the digitized received signal to extract the information or data bits conveyed in the received signal. This processing typically comprises demodulation, decoding, and error correction operations. As such, the baseband processor 70 is generally implemented in one or more digital signal processors (DSPs).

On the transmit side, the baseband processor 70 receives digitized data from the control system 72, which it encodes for transmission. The encoded data is output to the transmitter 64, where it is used by a modulator 84 to modulate a carrier signal that is at a desired transmit frequency. Power amplifier circuitry 86 amplifies the modulated carrier signal to a level appropriate for transmission from the antenna 66.

A user may interact with the mobile host 16 via the interface 76, which may include interface circuitry 88 associated with a microphone 90, a speaker 92, a keypad 94, and a display 96. The interface circuitry 88 typically includes analog-to-digital converters, digital-to-analog converters, amplifiers, and the like. Additionally, it may include a voice encoder/decoder, in which case it may communicate directly with the baseband processor 70.

The microphone 90 will typically convert audio input, such as the user's voice, into an electrical signal, which is then digitized and passed directly or indirectly to the baseband processor 70. Audio information encoded in the received signal is recovered by the baseband processor 70, and converted into an analog signal suitable for driving speaker 92 by the I/O and interface circuitry 88. The keypad 94 and display 96 enable the user to interact with the mobile host 16. For example, if the mobile host 16 is a mobile telephone, the keypad 94 and display 96 enable the user to input numbers to be dialed, address book information, or the like, as well as monitor call progress information.

According to the present invention, the mobile host 16 also includes a broadcast transceiver 98 and a GPS receiver 100. The GPS receiver 100 may generally be referred to as a location system. In this embodiment, the broadcast transceiver 98 includes a low noise amplifier (LNA) 102, filtering circuitry 103, a down-converter 104, and an analog-to-digital converter 106 forming a receiver. The broadcast transceiver 98 also includes a digital-to-analog converter 108, an up-converter 110, and power amplifier circuitry 112 forming a transmitter and a frequency synthesizer 113. The input of the LNA 102 and the output of the power amplifier circuitry 112 are coupled to the antenna 66 via the multiplexer 68.

In operation, when the mobile host 16 is within the cellular network 14 (FIG. 1), the cellular network 14 updates the RFID tag register 34 of the mobile host 16 by communicating the list of RFID tags to track to the baseband processor 70 through the receiver front end 63. The baseband processor 70 stores the list of RFID tags to track in the RFID tag register 34. The mobile host 16 also communicates with the cellular network 14 via the receiver front end 63 and the transmitter 64 such that the mobile host 16 provides any location and time stamp information stored in the RFID tag location register 44 to the cellular network 14.

The mobile host 16 uses the broadcast transceiver 98 to communicate with the RFID tag 12 (FIG. 1) and other mobile hosts 16. In this embodiment, the broadcast transceiver 98 enables communication with the active RFID tag 12 of FIG. 3A or the like. As discussed above, the active RFID tag 12 may periodically transmit its ID number. When the active RFID tag 12 is within the coverage area of the broadcast transceiver 98, a signal from the RFID tag 12 containing the ID number of the active RFID tag 12 is received by the antenna 66 and provided to the LNA 102 via the multiplexer 68. The LNA 102 amplifies the received signal. The received signal may then be filtered and down-converted to a baseband signal by the down-converter 104. The down-converted signal is then digitized by the A/D converter 106 and provided to the baseband processor 70 which processes the digital signal to obtain the ID of the active RFID tag 12. The baseband processor 70 compares the ID number of the RFID tag 12 to the list of RFID tags to track stored in the RFID tag register 34. If the RFID tag 12 is one of the RFID tags to track, the baseband processor 70 obtains the location of the mobile host 16 from the GPS receiver 100. It should be noted that the GPS receiver 100 may be coupled to its own antenna 114 or alternatively to the antenna 66 for receiving signals from the constellation of satellites forming the GPS. The baseband processor 70 then stores the location and a time stamp for the active RFID tag 12 in the RFID tag location register 44.

The broadcast transceiver 98 may also be used to communicate with the active RFID tag 12 of FIG. 3A that operates in sleep mode when it is not within the coverage area of the broadcast transceiver 98 of one of the mobile hosts 16. In this embodiment, the mobile host 16 periodically transmits an interrogation signal. For example, the baseband processor 70 may provide a digital representation of the interrogation signal to the D/A converter 108. The output of the D/A converter 108 is up-converted by the up-converter 110 and amplified by the power amplifier circuitry 112. The interrogation signal is then provided to the antenna 66 via the multiplexer 68 for transmission. In response to receiving the interrogation signal, the active RFID tag 12 transitions from sleep mode to a normal mode wherein the active RFID tag 12 periodically transmits its ID. Then, as discussed above, the ID is received by the mobile host 16 and compared to the list of RFID tags to track stored in the RFID tag register 34. If the ID corresponds to one of the RFID tags to track, then the location of the mobile host 16 is obtained via the GPS receiver 100, and the location and time stamp are stored in the RFID tag location register 44.

The broadcast transceiver 98 also enables communication between the mobile host 16 and another mobile host 16 within the coverage area of the broadcast transceiver 98. In general, the baseband processor 70 periodically transmits the IDs of the RFID tags to be tracked via the broadcast transceiver 98. In addition, once the mobile host 16 has obtained the location and time stamp for a particular RFID tag, the baseband processor 70 transmits the location and time stamp along with the ID of the RFID tag via the broadcast transceiver 98. In doing so, any mobile host 16 within the coverage area of the broadcast transceiver 98 can update the information in its RFID tag register 34 and RFID tag location register 44.

When the mobile host 16 is in the cellular network 14, the mobile host 16 communicates the location and time stamp of any of the RFID tags to track from the RFID tag location register 44 to the cellular network via the transmitter 64. This communication may be initiated by a polling signal from the cellular network 14. It should be noted that in the embodiment where the mobile host 16 is a mobile telephone, communication between the mobile host 16 and the cellular network 14 for purposes of tracking the RFID tag 12 may only occur during idle time such as when the mobile host 16 is not being used for a phone call.

FIG. 5 illustrates an embodiment of the mobile host 16 substantially the same as the embodiment illustrated in FIG. 4. However, in this embodiment, the broadcast transceiver 98 also enables communication with the passive RFID tag 12 of FIG. 3B and the like. In addition to the discussion of the mobile host 16 with respect to FIG. 4, the mobile host 16 of FIG. 5 includes an RFID excitation signal generator 116. Thus, when the mobile host 16 desires to initiate communication with the passive RFID tag 12, the RFID tag excitation signal generator 116 provides an RFID tag excitation signal to the antenna 66 via the multiplexer 68. As discussed above, the RFID tag excitation signal is rectified by the passive RFID tag 12 to obtain power for transmitting the ID of the passive RFID tag 12 back to the mobile host 16 via the broadcast transceiver 98. It should be noted that the embodiment of the mobile host 12 shown in FIG. 5 enables communication with both the active and passive RFID tag 12.

It may be beneficial to note that the operation of the broadcast transceiver 98 and tracking of the RFID tag 12 may be entirely invisible to the owner or operator of the mobile host 16. More specifically, the ID of the RFID tag 12 and location of the RFID tag 12 are only visible to the cellular network 14, which then provides the location information to the requesting person or entity.

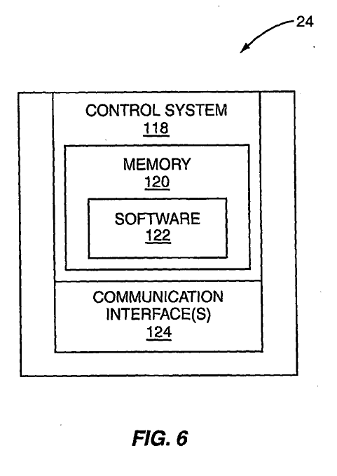

FIG. 6 illustrates an exemplary embodiment of the processing node 24 of FIG. 2. In general, the processing node 24 includes a control system 118 associated with memory 120 containing software 122. The processing node 24 also includes one or more communications interfaces 124 enabling communication with the cellular network 14, the RFID tag register 30, and the RFID tag location register 48. In operation, the control system 118 operates to run the software 122, wherein the software 122 provides the functionality of the processing node 24 described above.

The present invention provides substantial opportunity for variation without departing from the spirit or scope of the invention. For example, although the broadcast transceiver 98 is disclosed for direct communication between the mobile hosts 16, peer-to-peer communication may alternatively be used. Any type of direct wireless communication or wireless networking scheme may be used for communication between the mobile hosts 16. As another example, the types of objects that may be tracked by the system 10 of the present invention are too numerous to list, and any object such as passports, children, prisoners, parolees, inventory, automobiles, or the like may be tracked by the present invention.

Additionally, as discussed above, one or more of the mobile hosts 16 may include unique identifiers and operate as RFID tags 12. Extension of the functionality of the mobile host 16 to that of an RFID tag enables several additional applications with respect to the tracking system. Firstly, as the mobile hosts 16 also broadcast a unique identifier, short range low bandwidth text messaging over the broadcast channel would be possible. It would also be possible for authorities such as police to scan the broadcast band associated with the mobile hosts 16 and determine the people located within a desired area, such as a room. It would also be possible to establish a self tracking system wherein the mobile hosts 16 also log location and time a vehicle, such as a truck, over long distances. While the truck is out of the cellular network 14, the location register of the mobile host 16 is periodically appended with the location and time of the truck as it moves along its route. Once the truck re-enters the cellular network 14, the location and time information can then be downloaded to the cellular network 14 where a complete log of the position and time of the truck during its journey can be generated.

Those skilled in the art will recognize improvements and modifications to the preferred embodiments of the present invention. All such improvements and modifications are considered within the scope of the concepts disclosed herein and the claims that follow.

What is claimed is:

1. A mobile host in a system for tracking a Radio Frequency Identification (RFID) tag using a plurality of mobile hosts including the mobile host and a cellular network comprising:
a) first communication circuitry adapted to communicate with the cellular network;
b) second communication circuitry adapted to communicate with the RFID tag to determine an ID of the RFID tag when the RFID tag is within a coverage area of the second communication circuitry;
c) a location system adapted to determine a location of the mobile host; and
d) a control system adapted to: obtain the location of the mobile host from the location system when the RFID tag is within the coverage area of the second communication circuitry and store the location in associated memory as the location of the RFID tag.

2. The mobile host of claim 1 wherein the control system is further adapted to:
determine whether the RFID tag is one of at least one RFID tags to be tracked based on comparing the ID of the RFID tag to a list of IDs corresponding to the at least one RFID tags to be tracked; and
obtain the location of the mobile host from the location system and store the location in associated memory as the location of the RFID tag if the RFID tag is one of the at least one RFID tags to be tracked.

3. The mobile host of claim 2 wherein the control system is further adapted to receive the list of the at least one ID corresponding to the at least one RFID tag to be tracked from a processing node of the cellular network via the first communication circuitry when the mobile host is within the cellular network.

4. The mobile host of claim 1 wherein the control system is further adapted to communicate with others of the plurality of mobile hosts within the coverage area of the second communication circuitry via the second communication circuitry.

5. The mobile host of claim 2 wherein the control system is further adapted to receive the list of the at least one ID corresponding to the at least one RFID tag to be tracked from at least one other of the plurality of mobile hosts via the second communication circuitry when the mobile host is within a coverage area of the at least one other of the plurality of mobile hosts.

6. The mobile host of claim 2 wherein the control system is further adapted to provide the list of the at least one ID corresponding to the at least one RFID tag to be tracked to at least one other of the plurality of mobile hosts within the coverage area of the second communication circuitry via the second communication circuitry.

7. The mobile host of claim 1 wherein the control system is further adapted to provide the location of the RFID tag to at least one other of the plurality of mobile hosts within the coverage area of second communication circuitry via the second communication circuitry.

8. The mobile host of claim 1 wherein the control system is further adapted to provide the location of the RFID tag to a processing node of the cellular network via the first communication circuitry when the mobile host is within the cellular network.

9. The mobile host of claim 1 wherein the control system is further adapted to:
determine a time stamp for the location of the mobile host; and
store the time stamp as a time stamp for the location of the RFID tag.

10. The mobile host of claim 9 wherein the control system is further adapted to provide the location of the RFID tag and the time stamp for the location of the RFID tag to others of the plurality of mobile hosts within the coverage area of the second communication circuitry via the second communication circuitry.

11. The mobile host of claim 9 wherein the control system is further adapted to communicate the location of the RFID tag and the time stamp for the location of the RFID tag to a processing node of the cellular network via the first communication circuitry when the mobile host is within the cellular network.

12. The mobile host of claim 1 wherein the control system is further adapted to receive dynamic information in addition to the ID from the RFID tag and store the dynamic information in addition to the location for the RFID tag.

13. The mobile host of claim 1 wherein if the RFID tag is in a panic state, the control system is further adapted to:
receive the ID of the RFID tag and information indicating that the RFID is in the panic state from the RFID tag via the second communication circuitry; and
add the ID of the RFID tag to a list of IDs corresponding to at least one RFID tags to be tracked.

14. The mobile host of claim 1 wherein at least one of the plurality of mobile hosts in the system operates as the RFID tag.

15. A method of tracking a Radio Frequency Identification (RFID) tag using a cellular network comprising:
detecting the RFID tag within a coverage area of one of a first plurality of mobile hosts;
determining a location of the RFID tag;
storing the location of the RFID tag in the one of the first plurality of mobile hosts;
providing the location of the RFID tag to a second plurality of mobile hosts via broadcast transceivers associated with the one of the first plurality of mobile hosts and the second plurality of mobile hosts; and
providing the location of the RFID tag from the one of the first plurality of mobile hosts or one of the second plurality of mobile hosts to a processing node via the cellular network.

16. The method of claim 15 further comprising:
providing a list of at least one RFID tag to track including the RFID tag to a first subset of the first plurality of mobile hosts within the cellular network; and
providing the list of RFID tags to track to a second subset of the first plurality of mobile hosts via broadcast transceivers associated with each of the first and second subsets of the first plurality of mobile hosts.

17. The method of claim 16 wherein providing the list of RFID tags to track to the second subset of the first plurality of mobile hosts comprises:
providing the list of RFID tags to track from the first subset of the first plurality of mobile hosts to a first portion of the second subset of the first plurality of mobile hosts; and
providing the list of RFID tags to track from the first portion of the second subset of the first plurality of mobile hosts to a second portion of the second subset of the first plurality of mobile hosts.

18. The method of claim 15 wherein providing the location of the RFID tag to the second plurality of mobile hosts comprises:
providing the location of the RFID tag from the one of the first plurality of mobile hosts to a first portion of the second plurality of mobile hosts; and
providing the location of the RFID tag from the first portion of the second plurality of mobile hosts to a second portion of the second plurality of mobile hosts.

19. The method of claim 15 wherein determining the location comprises determining a time stamp for the location of the RFID tag.

20. The method of claim 16 wherein detecting the RFID tag comprises:
receiving an ID of the RFID tag from the RFID tag when the RFID tag is within the coverage area of the one of the first plurality of mobile hosts; and
determining whether the RFID tag is to be tracked by comparing the ID of the RFID tag to IDs within the list of RFID tags to track.

21. The method of claim 15 wherein determining the location of the RFID tag comprises determining a location of the one of the first plurality of mobile hosts, wherein the location of the one of the first plurality of mobile hosts is stored as the location of the RFID tag.

22. The method of claim 15 wherein if the RFID tag is in a panic state, detecting the RFID tag comprises:
determining that the RFID tag is in the panic state based on information from the RFID tag;
adding the ID of the RFID tag to a list of IDs of at least one RFID tag to be tracked.

23. A system for tracking a Radio Frequency Identification (RFID) tag using a cellular network comprising:
a processing node associated with the cellular network and comprising:
a) a communication interface coupled to the cellular network; and
b) a control system adapted to:
i) receive a request to track the RFID tag from a requesting node;
ii) provide the request to track the RFID tag to a first plurality of mobile hosts within the cellular network via the communication interface; and
iii) receive a location of the RFID tag from a mobile host within the cellular network via the communication interface, wherein the mobile host may or may not be one of the first plurality of mobile hosts to which the request was provided.

24. The system of claim 23 wherein the first plurality of mobile hosts provides the request to a second plurality of mobile hosts via broadcast transceivers associated with each of the first and second pluralities of mobile hosts, one of the first and second plurality of mobile hosts determines the location of the RFID tag, and the location is provided to a third plurality of mobile hosts including the mobile host via broadcast transceivers associated with the one of the first and second pluralities of mobile hosts and the third plurality of mobile hosts.

25. The system of claim 23 wherein the control system is further adapted to receive a plurality of locations and corresponding time stamps for the RFID tag from at least one mobile host within the cellular network via the communication interface and to store a number of most recent ones of the locations for the RFID tag.
